(19) United States
(12) Patent Application Publication
(10) Pub. No.: US 2026/0138055 A1
(43) Pub. Date: May 21, 2026

(54) Method and System for Anchoring an Underdrain

(71) Applicant: Xylem Water Solutions Zelienople LLC, Zelienople, PA (US)

(72) Inventors: David E. Roeser, Wexford, PA (US); Matthew Sudak, Mars, PA (US); Robert J. Green, Butler, PA (US); Matthew Davis, Aliquippa, PA (US)

(21) Appl. No.: 19/119,118

(22) PCT Filed: Oct. 9, 2023
(86) PCT No.: PCT/US2023/034756

§ 371 Date: Apr. 8, 2025

Related U.S. Application Data
(60) Provisional application No. 63/414,596, filed on Oct. 10, 2022.

(51) Int. Cl. B01D 24/00; B01D 24/20; B01D 24/46

(52) U.S. Cl. CPC B01D 24/001; B01D 24/20; B01D 24/4631

(57) ABSTRACT

A system for anchoring an underdrain is disclosed. The underdrain having a top surface, a bottom surface positioned opposite the top surface, a first side, and a second side positioned opposite the first side. A base grout layer is on a floor surface of a water filtration system. A reinforcement structure is within the base grout layer, with a protruding portion of the reinforcement structure extending from the base grout layer. A method includes positioning the underdrain on the base grout, with the protruding portion of the reinforcement structure positioned along at least one of the first side and the second side of the underdrain, and installing a fill grout layer onto the base grout layer, with the fill grout layer covering at least a portion of the protruding portion of the reinforcement structure.

### CROSS-REFERENCE TO RELATED APPLICATION

The present application claims priority to U.S. Provisional Application Ser. No. 63/414,596, filed Oct. 10, 2022, the disclosure of which is hereby incorporated by reference in its entirety.

### BACKGROUND OF THE INVENTION

### Field of the Invention

The present invention relates to an underdrain filter block and, more particularly, to a filter block used in draining and backwashing a filtering media in a filter bed and a method of securing the filter block to the filter floor.

### Description of Related Art

Underdrain filter blocks provide a filter bottom by assembling a number of filter blocks together to provide an upper surface for supporting a filter media. The filter bottom upper surface is provided with openings to allow the flow of filtered liquid from the filter media to pass into the filter bottom where conduits carry the filtered liquid from the filter. The conduits also serve to provide backwashing fluids, such as gas or liquid or both, to the filter media for cleaning. U.S. Pat. Nos. 5,108,627 and 9,072,990 disclose filter underdrain blocks and are each hereby incorporated by reference in their entirety.

Underdrain filter blocks may be susceptible to uplift failure due to excessive pressure caused by headloss through the underdrain. Normal differential operating pressures typically range from 2-5 psi, with pressures over 5 psi considered excessive. The headloss or excessive pressure tends to force the block off the filter floor as a bottom section of the underdrain block deflects or deforms. Further, underdrain filter blocks may be installed by pouring a first layer of base grout onto a floor surface to level the floor surface and the underdrain filter block is installed on top of the base grout. A second layer or pour of grout is then installed later, such as less than 24 hours, to fill the voids in between the underdrain filter blocks. With two separate pours, a cold joint is formed between the layers, which is a weak point of the installation of the underdrain filter blocks.

### SUMMARY OF THE INVENTION

In one aspect or embodiment, a method for anchoring an underdrain including a top surface, a bottom surface positioned opposite the top surface, a first side, and a second side positioned opposite the first side, includes: installing a base grout layer on a floor surface of a water filtration system; positioning a reinforcement structure within the base grout layer, with a protruding portion of the reinforcement structure extending from the base grout layer; positioning the underdrain on the base grout, with the protruding portion of the reinforcement structure positioned along at least one of the first side and the second side of the underdrain; and installing a fill grout layer onto the base grout layer, with the fill grout layer covering at least a portion of the protruding portion of the reinforcement structure.

The fill grout layer may cover a portion of the underdrain. The reinforcement structure may be wire mesh. The reinforcement structure may include a base, a first leg extending from the base, and a second leg extending from the base, with the first leg positioned along the first side of the underdrain and the second leg is positioned along the second side of the underdrain when the underdrain is positioned on the base grout. Installing the base grout layer may include encapsulating the base of the reinforcement structure within the base grout layer. The reinforcement member may extend an entire length of the underdrain when the underdrain is positioned on the base grout. The reinforcement structure may be positioned on the floor surface of the water filtration system prior to installing the base grout layer.

The reinforcement structure may provide a mechanical connection between the base grout layer and the fill grout layer. The base grout layer and the fill grout layer may be installed by pouring or pumping a cementitious material. The base grout layer and the fill grout layer may include a cementitious material.

In a further aspect or embodiment, a system for anchoring an underdrain for a water filtration system includes an underdrain having a top surface, a bottom surface positioned opposite the top surface, a first side, and a second side positioned opposite the first side, and a reinforcement member configured to be installed along at least one of the first side and the second side of the underdrain when the underdrain is set on a base grout installation.

The reinforcement structure of the system may be wire mesh. The reinforcement structure of the system may include a base, a first leg extending from the base, and a second leg extending from the base, where the first leg is configured to be positioned along the first side of the underdrain and the second leg is configured to be positioned along the second side of the underdrain when the underdrain is set on the base grout installation. The reinforcement member may be configured to extend an entire length of the underdrain when the underdrain is positioned on the base grout. The reinforcement structure may be configured to provide a mechanical connection between the base grout layer and the fill grout layer.

The present disclosure may be further defined by the following clauses:
Clause 1. A method for anchoring an underdrain comprising a top surface, a bottom surface positioned opposite the top surface, a first side, and a second side positioned opposite the first side, the method comprising: installing a base grout layer on a floor surface of a water filtration system; positioning a reinforcement structure within the base grout layer, with a protruding portion of the reinforcement structure extending from the base grout layer; positioning the underdrain on the base grout, with the protruding portion of the reinforcement structure positioned along at least one of the first side and the second side of the underdrain; and installing a fill grout layer onto the base grout layer, with the fill grout layer covering at least a portion of the protruding portion of the reinforcement structure.
Clause 2. The method of clause 1, wherein the fill grout layer covers a portion of the underdrain.
Clause 3. The method of clause 1 or clause 2, wherein the reinforcement structure comprises wire mesh
Clause 4. The method of any of clauses 1-3, wherein the reinforcement structure comprises a base, a first leg extending from the base, and a second leg extending from the base, and wherein the first leg is positioned along the first side of the underdrain and the second leg is positioned along the second side of the underdrain when the underdrain is positioned on the base grout.
Clause 5. The method of clause 4, wherein installing the base grout layer comprises encapsulating the base of the reinforcement structure within the base grout layer.
Clause 6. The method of any of clauses 1-5, wherein the reinforcement member extends an entire length of the underdrain when the underdrain is positioned on the base grout.
Clause 7. The method of any of clauses 1-6, wherein the reinforcement structure is positioned on the floor surface of the water filtration system prior to installing the base grout layer.
Clause 8. The method of any of clauses 1-7, wherein the reinforcement structure provides a mechanical connection between the base grout layer and the fill grout layer.
Clause 9. The method of any of clauses 1-8, wherein the base grout layer and the fill grout layer are installed by pouring or pumping a cementitious material.
Clause 10. The method of any of clauses 1-9, wherein the base grout layer and the fill grout layer comprises a cementitious material.
Clause 11. A system for anchoring an underdrain for a water filtration system, the system comprising: an underdrain comprising a top surface, a bottom surface positioned opposite the top surface, a first side, and a second side positioned opposite the first side; and a reinforcement member configured to be installed along at least one of the first side and the second side of the underdrain when the underdrain is set on a base grout installation.
Clause 12. The system of clause 11, wherein the reinforcement structure comprises wire mesh.
Clause 13. The system of clause 11 or clause 12, wherein the reinforcement structure comprises a base, a first leg extending from the base, and a second leg extending from the base, and wherein the first leg is configured to be positioned along the first side of the underdrain and the second leg is configured to be positioned along the second side of the underdrain when the underdrain is set on the base grout installation.
Clause 14. The system of any of clauses 11-13, wherein the reinforcement member is configured to extend an entire length of the underdrain when the underdrain is positioned on the base grout.
Clause 15. The system of any of clauses 11-14, wherein the reinforcement structure is configured to provide a mechanical connection between the base grout layer and the fill grout layer.

### BRIEF DESCRIPTION OF THE DRAWINGS

FIG. 1 is schematic view of a system for anchoring an underdrain according to one aspect or embodiment of the present application;

FIG. 2 is a partial perspective view of the system of FIG. 1, with the underdrain omitted for clarity;

FIG. 3 is a perspective view of the system of FIG. 1;

FIG. 4 is an enlarged perspective view of area A shown in FIG. 3; and

FIG. 5 is a front view of the system of FIG. 1.

Corresponding reference characters indicate corresponding parts throughout the several views. The exemplifications set out herein illustrate exemplary aspects of the disclosure, and such exemplifications are not to be construed as limiting the scope of the disclosure in any manner.

### DETAILED DESCRIPTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

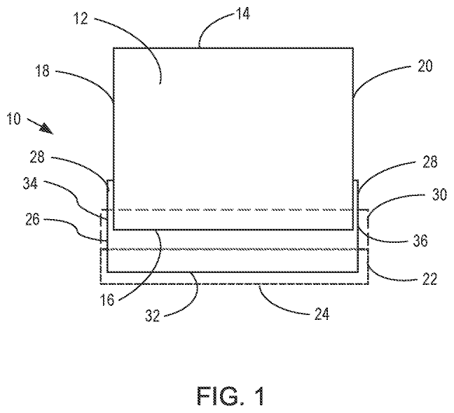

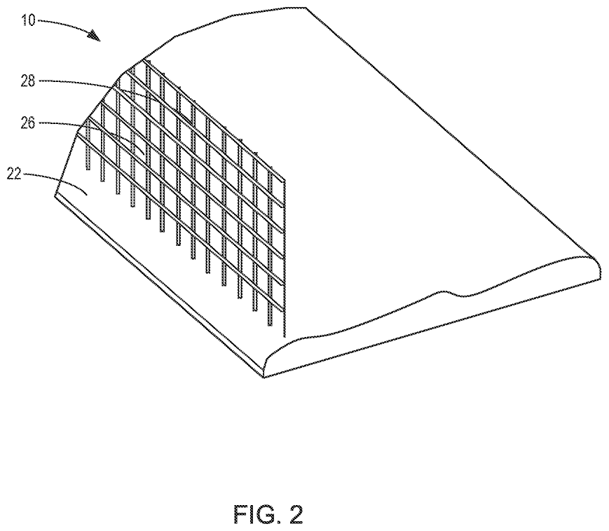

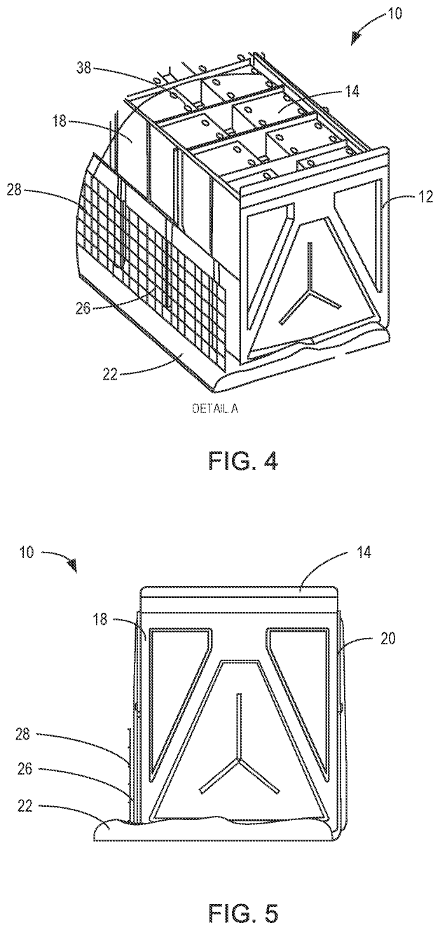

Referring to FIGS. 1-5, a method and system 10 for anchoring an underdrain 12 according to one aspect or embodiment of the present application is shown. The underdrain 12 includes a top surface 14, a bottom surface 16 positioned opposite the top surface 14, a first side 18, and a second side 20 positioned opposite the first side 18. The method includes:
installing a base grout layer 22 on a floor surface 24 of a water filtration system; positioning a reinforcement structure 26 within the base grout layer 22, with a protruding portion 28 of the reinforcement structure 26 extending from the base grout layer 22; positioning the underdrain 12 on the base grout layer 22, with the protruding portion 28 of the reinforcement structure 26 positioned along at least one of the first side 18 and the second side 20 of the underdrain 12; and installing a fill grout layer 30 onto the base grout layer 22, with the fill grout layer 30 covering at least a portion of the protruding portion 28 of the reinforcement structure 26.

The reinforcement structure 26 is configured to provide a mechanical connection between the base grout layer 22 and the fill grout layer 30 and strengthening the overall installation of the underdrain 12. In some aspects or embodiments, the reinforcement structure 26 increases the installation strength by 50% compared to installations without the reinforcement structure 26. In some aspects or embodiments, the reinforcement structure 26 is positioned on the floor surface 24 of the water filtration system prior to installing the base grout layer 22, although the base grout layer 22 could be poured with the reinforcement structure 26 subsequently positioned within the base grout layer 22. The base grout layer 22 and the fill grout layer 30 may be formed from a cementitious material that is poured, pumped, or otherwise positioned on the floor surface 24. In some aspects or embodiments, the installation of the fill grout layer 30 onto the base grout layer 22, with the fill grout layer 30 covering at least a portion of the protruding portion 28 of the reinforcement structure 26, takes place after the base grout layer 22 has initially set and/or partially cured. In some aspects or embodiments, the fill grout layer 30 is installed 24 hours or less after installing the base grout layer 22.

Referring to FIG. 1, the fill grout layer 30 covers a portion of the underdrain 12. The fill grout layer 30 may extend up to at least a portion of the first and second sides 18, 20 of the underdrain 12. Although the fill grout layer 30 only covers a portion of the protruding portion 28 of the reinforcement structure 26, the fill grout layer 30 may entirely encapsulate the protruding portion 28.

Referring again to FIGS. 1-5, in one aspect or embodiment, the reinforcement structure 26 is wire mesh, such as welded wire mesh. The wire mesh may be formed from steel, polymer, resin, or a combination of material. The reinforcement structure 26 may include different sizes, patterns, materials, or features to increase or change the installation strength and retention strength of the underdrain 12. Although not shown, the reinforcement structure 26 may include one or more anchoring portions to further secure the reinforcement structure 26 within the base grout layer 22 and/or filter basin floor.

Referring to FIG. 1, in one aspect or embodiment, the reinforcement structure 26 includes a base 32, a first leg 34 extending from the base 32, and a second leg 36 extending from the base 32. The first leg 34 is positioned along the first side 18 of the underdrain 12 and the second leg 36 is positioned along the second side 20 of the underdrain 12 when the underdrain 12 is positioned on the base grout layer 22. Installing the base grout layer 22 encapsulates the base 32 of the reinforcement structure 26 within the base grout layer 22. In some aspects or embodiments, the base 32 is not provided with only the first leg 34 and the second leg 36 being provided along the first and second sides 18, 20 of the underdrain 12. In other words, the reinforcement structure 26 may be a length of wire mesh pressed into the base grout layer 22 next to the first and second sides 18, 20 of the underdrain 12.

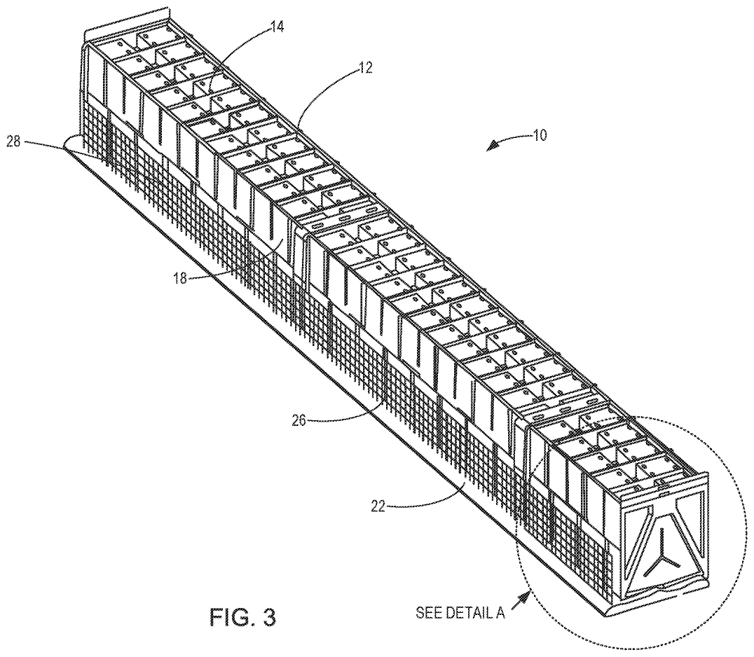

Referring to FIG. 3, the reinforcement structure 26 extends an entire length of the underdrain 12 when the underdrain 12 is positioned on the base grout layer 12, although the reinforcement structure 26 may only extend a portion of the length of the underdrain 12 or may only be provided at predetermined positions along the underdrain 12.

Although a single underdrain 12 is shown, a plurality of underdrains 12 may be positioned adjacent to each other with a plurality of reinforcement structures 26 extending between adjacent sides 18, 20 of the underdrains 12 prior to the fill grout layer 30 being poured or positioned between each of the plurality of underdrains 12. The top surface 14 of the underdrain 12 defines a plurality of openings 38. The underdrain 12 may include one or more passageways, openings, and/or features and function in a similar manners as the underdrains discussed in U.S. Pat. Nos. 5,108,627 and 9,072,990. In some aspects or embodiments, the underdrain 12 is manufactured from plastic, such as by plastic injection molding, although other suitable materials and manufacturing may be utilized.

In some aspects or embodiments, a plurality of underdrains 12, when assembled together, provide an upper surface for supporting a filter media. The plurality of openings 38 are configured to allow the flow of filtered liquid from the filter media to pass into each underdrain 12, with conduits or passageways carrying the filtered liquid from the filter and also serving to provide backwashing fluids, either gas or liquid or both, to the filter media for cleaning the filter media. Each underdrain 12 may be covered with filtering media, such as aggregate or other media having a particle size that is too large to path through the openings 38, with one or more additional layers of filter media of varying sizes provided. A liquid to be filtered, such as water, enters from above each underdrain 12, passes downwardly through the layers of the filtering media, through the openings 38, through conduits or passageways in each underdrain 12, and out through another portion of the system, such as a take-off flume. The liquid may move through the filtering media and the underdrains via gravity.

During backwashing, the flow of fluid to be filtered is stopped and a washing medium is forced through each underdrain 12 in a reverse direction to clean the filter media. The backwashing may first include backwashing using air to loosen and separate the particles of the filter bed and then subsequently backwashing with water to carry particles upward and away from the filter bed. Air and water may also be provided simultaneously. In some aspects or embodiments, each underdrain 12 includes primary liquid conduits in a lower portion of the underdrain 12 adjacent to the bottom surface 16 and gas conduit in an upper portion of the underdrain 12 adjacent to the top surface 14.

As discussed above, the method and system 10 discussed above and shown in FIGS. 1-5 is configured to provide a mechanical connection between the base grout layer 22 and the fill grout layer 30 and strengthening the overall installation of the underdrain 12 to prevent failure, such as uplift failure or lifting of the underdrain 12 from the base grout layer 22, of the installation during use of the underdrain as described above.

Elements of one disclosed aspect can be combined with elements of one or more other disclosed aspects to form different combinations, all of which are considered to be within the scope of the present invention.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which falls within the limits of the appended claims.

The invention claimed is

1. A method for anchoring an underdrain comprising a top surface, a bottom surface positioned opposite the top surface, a first side, and a second side positioned opposite the first side, the method comprising:
installing a base grout layer on a floor surface of a water filtration system;
positioning a reinforcement structure within the base grout layer, with a protruding portion of the reinforcement structure extending from the base grout layer;
positioning the underdrain on the base grout, with the protruding portion of the reinforcement structure positioned along at least one of the first side and the second side of the underdrain; and
installing a fill grout layer onto the base grout layer, with the fill grout layer covering at least a portion of the protruding portion of the reinforcement structure.

2. The method of claim 1, wherein the fill grout layer covers a portion of the underdrain.

3. The method of claim 1, wherein the reinforcement structure comprises wire mesh.

4. The method of claim 1, wherein the reinforcement structure comprises a base, a first leg extending from the base, and a second leg extending from the base, and wherein the first leg is positioned along the first side of the underdrain and the second leg is positioned along the second side of the underdrain when the underdrain is positioned on the base grout.

5. The method of claim 4, wherein installing the base grout layer comprises encapsulating the base of the reinforcement structure within the base grout layer.

6. The method of claim 1, wherein the reinforcement member extends an entire length of the underdrain when the underdrain is positioned on the base grout.

7. The method of claim 1, wherein the reinforcement structure is positioned on the floor surface of the water filtration system prior to installing the base grout layer.

8. The method of claim 1, wherein the reinforcement structure provides a mechanical connection between the base grout layer and the fill grout layer.

9. The method of claim 1, wherein the base grout layer and the fill grout layer are installed by pouring or pumping a cementitious material.

10. The method of claim 1, wherein the base grout layer and the fill grout layer comprises a cementitious material.

11. A system for anchoring an underdrain for a water filtration system, the system comprising:
an underdrain comprising a top surface, a bottom surface positioned opposite the top surface, a first side, and a second side positioned opposite the first side; and
a reinforcement member configured to be installed along at least one of the first side and the second side of the underdrain when the underdrain is set on a base grout installation.

12. The system of claim 11, wherein the reinforcement structure comprises wire mesh.

13. The system of claim 11, wherein the reinforcement structure comprises a base, a first leg extending from the base, and a second leg extending from the base, and wherein the first leg is configured to be positioned along the first side of the underdrain and the second leg is configured to be positioned along the second side of the underdrain when the underdrain is set on the base grout installation.

14. The system of claim 11, wherein the reinforcement member is configured to extend an entire length of the underdrain when the underdrain is positioned on the base grout.

15. The system of claim 11, wherein the reinforcement structure is configured to provide a mechanical connection between the base grout layer and the fill grout layer.
